(19) United States
(12) Patent Application Publication
(10) Pub. No.: US 2007/0091619 A1
(43) Pub. Date: Apr. 26, 2007

(54) ADJUSTABLE LAMP SHADE

(76) Inventor: Jaihyuk Lee, Kingston, Surrey (GB)

Correspondence Address: QUICKPATENTS, INC., 31877 DEL OBISPO, SUITE 202, SAN JUAN CAPISTRANO, CA, 92675, US

(21) Appl. No.: 11/307,973

(22) Filed: Mar. 1, 2006

(30) Foreign Application Priority Data
Oct. 26, 2005 (EP) 000423801-0001

(51) Int. Cl. F21V 11/06

(52) U.S. Cl. 362/354; 362/290; 362/279; 362/352; 362/360

(57) ABSTRACT

A lamp shade for placement around a lamp is disclosed. The lamp shade comprises a plurality of elongated slats having an aperture proximate to each end thereof. Each end of each slat is interlaced with another end of at least one other slat such that apertures of each slat are coaxially aligned and form a pivot axis therethrough. A plurality of such aligned slats in succession form a geometrically shaped ring, and a plurality of such rings stacked on top of each other such that each pivot axis of one ring is substantially aligned with the pivot axis of an immediately adjacent ring to form a column. A flexible cord traverses each coaxially aligned aperture of each slat along each aligned pivot axis. Each flexible cord includes a stopping means at each end thereof, such as a knot formed in the flexible cord. In embodiments wherein each geometrically shaped ring is comprised of an even number of slats, the lamp shade can be folded into a generally flat configuration and then rolled into a rolled configuration for convenient storage and transportation thereof. In use, the column is placed around the lamp such that light is diffused by the interlaced slats. The slats are positionable so that one geometrically shaped ring may be only slightly differently shaped than its immediately adjacent rings. As such the lamp shade may be adjustable, the column taking any number of various forms. The effect of adjusting the lamp shade allows a variable pattern of light to escape from the sides of the lamp shade and from the open top end thereof.

### CROSS-REFERENCE TO RELATED APPLICATIONS

This patent application is related to European Community Design No. 000423801-0001, filed on Oct. 26, 2005.

### STATEMENT REGARDING FEDERALLY SPONSORED RESEARCH AND DEVELOPMENT

Not Applicable.

### FIELD OF THE INVENTION

This invention relates to lamp shade structures, and more particularly to an adjustable lamp shade structure.

### DISCUSSION OF RELATED ART

Decorative lamp shades are well known in the art, most of which take the form of a conventional lamp shade for placement in some manner around a light bulb of a lamp. Few prior art lamp shades use wooden or other interlaced slats connected together through flexible cords to create an adjustable lamp shade. While there are several prior art devices that do employ slats and flexible linkages, no prior art device has been found that provides the advantages of the present device.

For example, US Patent Application 2004/0027830 to Chen on Feb. 12, 2004 teaches a lamp shade formed by a plurality of slated rings, each ring held to another by a flexible linkage. However, in such a device gravity defines the shape of the lamp shade, and it is not adjustable to suit a particular lighting application, desired mood, or environment.

U.S. Pat. No. 5,181,776 to Tseng on Jan. 26, 1993 teaches a lamp shade device made from slats. However, such a lamp shade takes a more traditional lamp shade shape, and is not adjustable.

U.S. Pat. No. 4,605,996 to Payne on Aug. 12, 1986 teaches a knock down lamp shade, but when erected such a device is not adjustable. Other non-adjustable lamp shades that use slats and flexible linkages are disclosed in U.S. Pat. No. 4,035,633 to Grumbeck on Jul. 12, 1977; U.S. Pat. No. 1,943,928 to Pierce on Jan. 16, 1934; U.S. Pat. No. 2,637,805 to Jacobs on May 5, 1953; and U.S. Pat. No. 1,745,365 to Feiler on Feb. 4, 1930. U.S. Pat. No. 3,169,251 to Humes, Jr. on Feb. 16, 1965 teaches a collapsible honeycomb hat that has an appearance similar to that of a lamp shade, and that also collapses into a rolled configuration much like the present invention. However, such a device is ill-suited for use as an actual lamp shade, and does not provide the adjustable nature nor use slats as does the present invention.

Several foreign references use slats to achieve a somewhat similar look to the present invention. For example, JP 11-176218,A (1999) to Saito Kokichi, and JP 43-006281,Y (1968) teach lamp shades using stacks of slats. Both of these patents, however, do not teach an adjustable lamp shade. The -281 reference includes rings of acrylic slats having apertures at either end for receiving a rigid metal pole, a plurality of rings forming a rigid, non-adjustable non-deformable column. UK Design Patent 3014312 to Wins, titled Decorative Lighting Apparatus, teaches a series of stacked rectangles formed by interlaced slats. Again, however, such a device is not adjustable, the slats being fixed with respect to each other.

Therefore, there is a need for a decorative lamp shade that uses slats connected together through a plurality of flexible linkages to create a unique, infinitely adjustable lamp shade. The needed device would be relatively inexpensive to manufacture, and could be made using a wide variety of materials, slat sizes, and heights. Further, such a needed device would be configurable in either flat or rolled configurations for easy storage and transport. The present invention accomplishes these objectives.

### SUMMARY OF THE INVENTION

The present invention is a lamp shade for placement around a lamp. The lamp shade comprises a plurality of elongated slats, each of which comprises a top surface, a bottom surface, and at least one side surface. Each slat further includes an aperture proximate to each of a first end and a second end thereof. Each aperture traverses one slat from the top surface through the slat to the bottom surface. Each first end of each slat is interlaced with the second end of at least one other slat such that apertures of each slat are coaxially aligned and form a pivot axis therethrough. A plurality of such aligned slats in succession form a geometrically shaped ring, and a plurality of such rings stacked on top of each other such that each pivot axis of one ring is substantially aligned with the pivot axis of an immediately adjacent ring form a column.

A flexible cord traverses each coaxially aligned aperture of each slat along each aligned pivot axis. Each flexible cord includes a stopping means at each end thereof, such as a knot formed in the flexible cord.

Preferably each geometrically shaped ring is comprised of an even number of slats, such as six. As such, the lamp shade can be folded into a generally flat configuration and then rolled into a rolled configuration. Such a rolled configuration allows the lamp shade to be conveniently stored, packaged, and transported in a compact form. In use, the column may be placed around the lamp such that light is diffused by the interlaced slats. The slats are positionable so that one geometrically shaped ring may be only slightly differently shaped than its immediately adjacent rings. As such the lamp shade may be adjustable, the column taking any number of various forms. The effect of adjusting the lamp shade allows a variable pattern of light to escape from the sides of the lamp shade and from the open top end thereof.

The present invention is a decorative lamp shade that uses slats connected together through a plurality of flexible linkages to create a unique, infinitely adjustable lamp shade. The present device is relatively inexpensive to manufacture, and can be made using a wide variety of materials, slat sizes, heights, and geometric configurations. Further, the present lamp shade is configurable in either flat or rolled configurations for easy storage and transport. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is a perspective view of the invention, illustrating a column of geometrically shaped rings, each ring being generally a hexagon shape made from six slats;

FIG. 2 is a perspective view of the invention, illustrating the column of FIG. 1 but wherein each ring is a slightly different shape than adjacent rings;

FIG. 3A is a partial perspective view of the invention, taken generally along lines 3A of FIG. 1, illustrating a flexible cord of the invention traversing apertures in each of the slats;

FIG. 3B is a partial front elevational view of two adjacent slats of the invention, illustrating the apertures therein and the flexible cord traversing therethrough;

FIG. 4 is a partially exploded view of the invention, illustrating the lamp shade of the invention as fitting over and around a lamp;

FIG. 5A is a perspective illustration of the invention, illustrating the column wherein each ring has an even number of slats, and wherein the lamp shade has been folded into a generally flat configuration;

FIG. 5B is a perspective illustration of the invention, illustrating the lamp shade in a rolled configuration for storage or transport;

FIG. 6 is a perspective illustration of the invention, illustrating the lamp shade as attached to a support bracket for fixing the lamp shade to a lamp;

FIG. 7 is a partial cross-sectional view of the invention, taken generally along lines 7-7 of FIG. 6, showing the support bracket as fixed to the lamp shade and lamp;

FIG. 8 is a top plan view of a ring of the invention, wherein the ring comprises six slats and is formed generally into a hexagon shaped ring;

FIG. 9 is a front elevational view of the invention, illustrating one configuration of the lamp shade;

FIG. 10 is a front elevational view of the invention, illustrating an alternate configuration of the lamp shade;

FIG. 11 is a front elevational view of the invention, illustrating an alternate configuration of the lamp shade;

FIG. 12 is a partial perspective view of the invention, taken generally along lines 3-3 of FIG. 1, illustrating an alternate embodiment further including a gauge ring fixed between each adjacent slat on the flexible cord; and

FIG. 13 is a partial exploded view of the invention, illustrating a support bracket for holding the lamp shade to the lamp.

### DETAILED DESCRIPTION OF THE PREFERRED EMBODIMENT

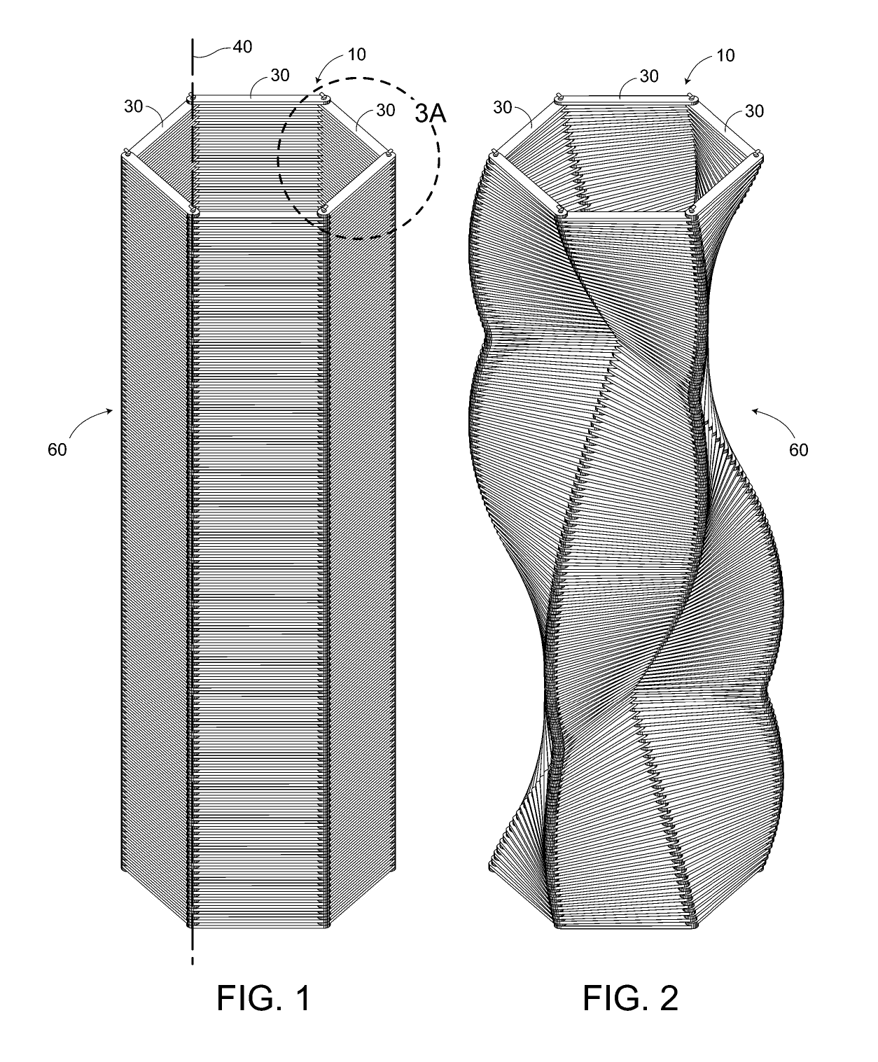

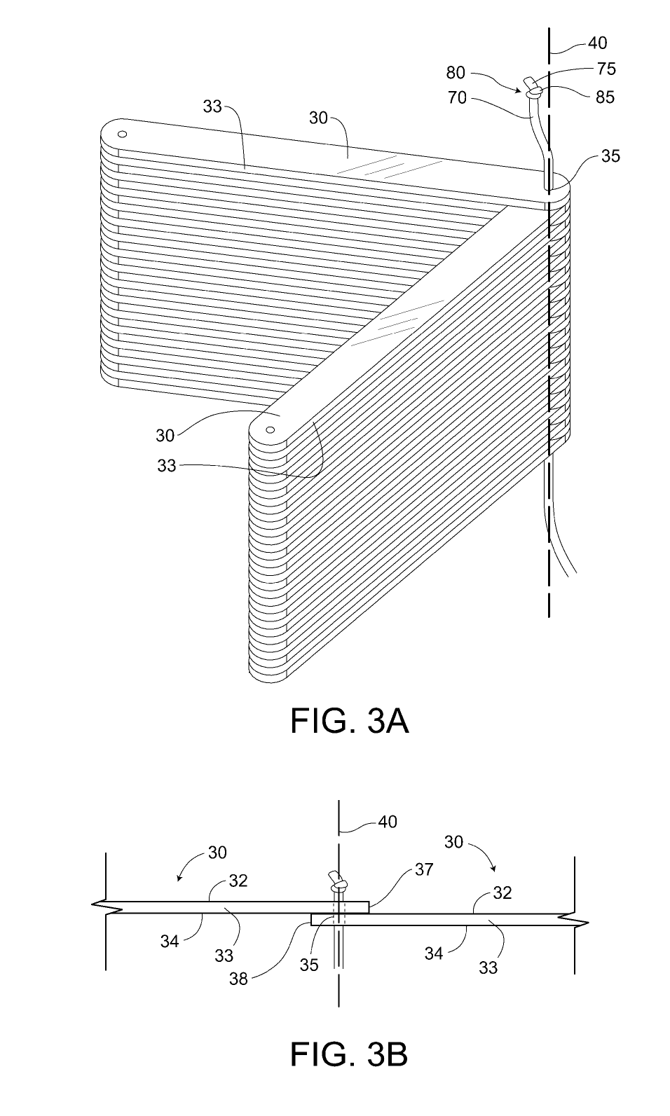

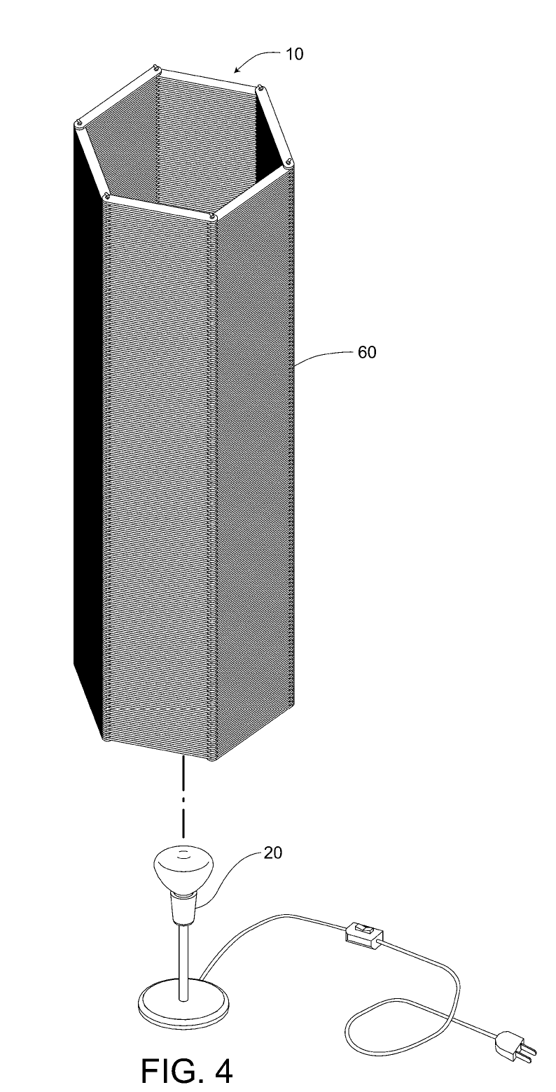

The present invention is a lamp shade 10 for placement around a lamp 20 (FIGS. 1 and 4). The lamp shade 10 comprises a plurality of elongated slats 30, each of which comprises a top surface 32, a bottom surface 34, and at least one side surface 33. Each slat 30 further includes an aperture 35 proximate to each of a first end 37 and a second end 38 thereof (FIGS. 3A and 3B). Each aperture 35 traverses one slat 30 from the top surface 32 through the slat 30 to the bottom surface 34.

Each first end 37 of each slat 30 is interlaced with the second end 38 of at least one other slat 30 such that apertures 35 of each slat 30 are coaxially aligned. The coaxially aligned apertures 35 form a pivot axis 40 therethrough (FIGS. 3A and 3B). A plurality of such aligned slats 30 in succession form a geometrically shaped ring 50 (FIG. 8), and a plurality of such rings 50 stacked on top of each other such that each pivot axis of one ring 50 is substantially aligned with the pivot axis of an immediately adjacent ring 50 form a column 60 (FIGS. 1 and 2).

A flexible cord 70 traverses each coaxially aligned aperture 5 of each slat 30 along each aligned pivot axis 40. Each flexible cord 70 includes a stopping means 80 at each end 75 thereof. While the preferred stopping means 80 is a knot 85 formed in the flexible cord 70, clearly the stopping means 80 may take some other form, such as a rubber grommet, a spring clip, a rivet, or the like (not shown), as is known in the art. Preferably the flexible cord 70 is a flexible rubber or plastic cord. In one alternate embodiment of the invention, however, the flexible cord 70 is also an elastic cord (not shown). Alternately, the flexible cord 70 is a metal wire, yarn, or any other suitable flexible material (not shown).

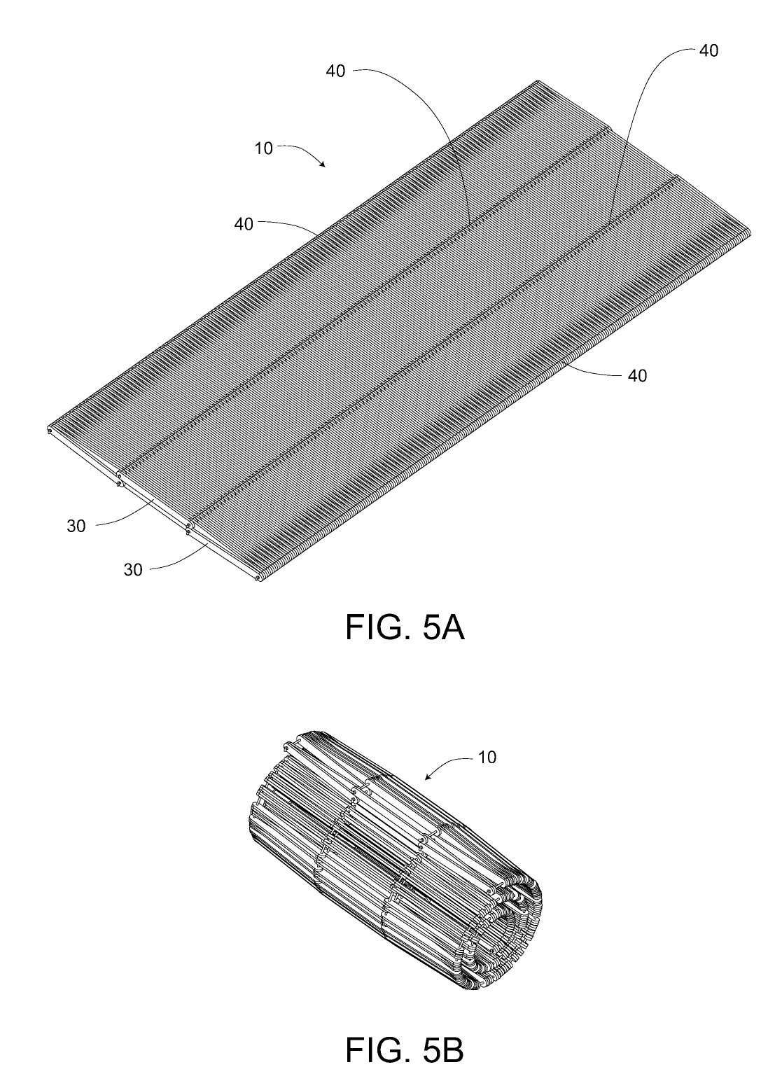

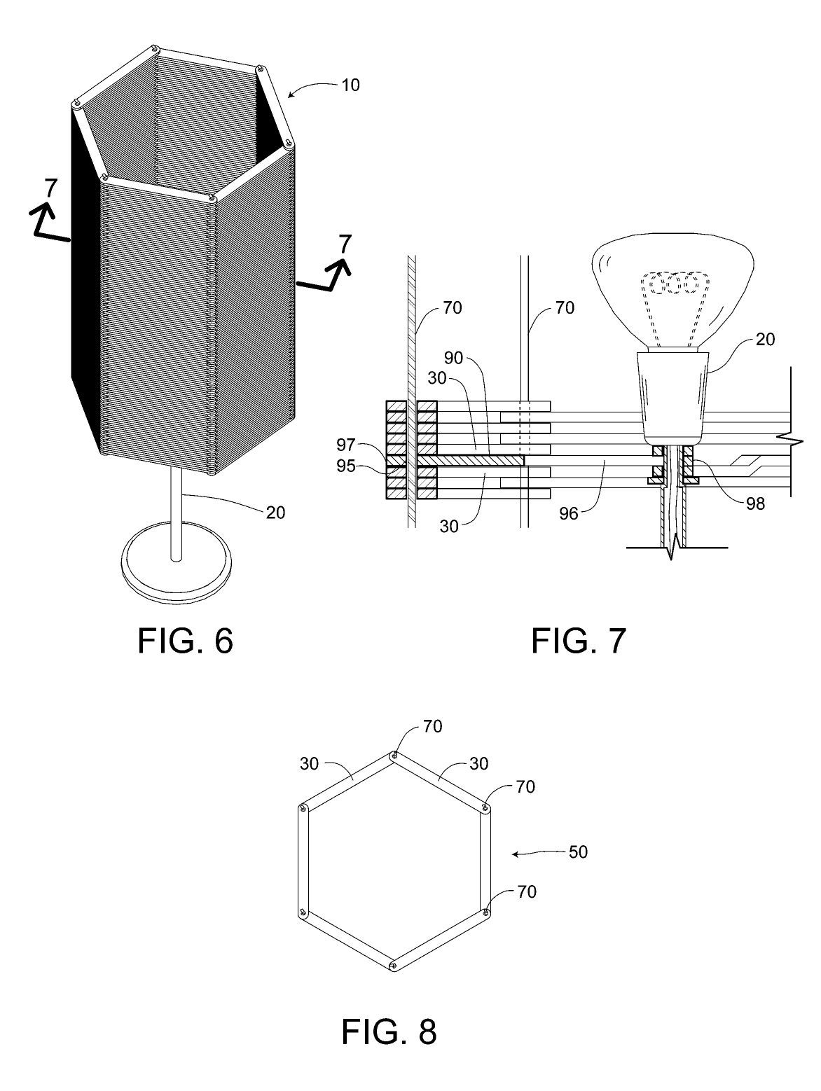

Preferably each geometrically shaped ring 50 is comprised of an even number of slats 30, such as six. As such, the lamp shade 10 can be folded into a generally flat configuration, as illustrated in FIG. 5A, and then rolled into a rolled configuration, as illustrated in FIG. 5B. Such a rolled configuration allows the lamp shade 10 to be conveniently stored, packaged, and transported in a compact form. Clearly, however, any practical number of slats 30 could be used for each shaped ring 50, such as three, four, five, six, seven, eight, nine, ten, eleven, twelve, and so on. While rings 50 with odd numbers of slats 30 cannot be easily folded flat and then rolled into a rolled configuration, lamp shades 10 made with odd numbers of slats do provide a distinct look and may be suitable for some applications.

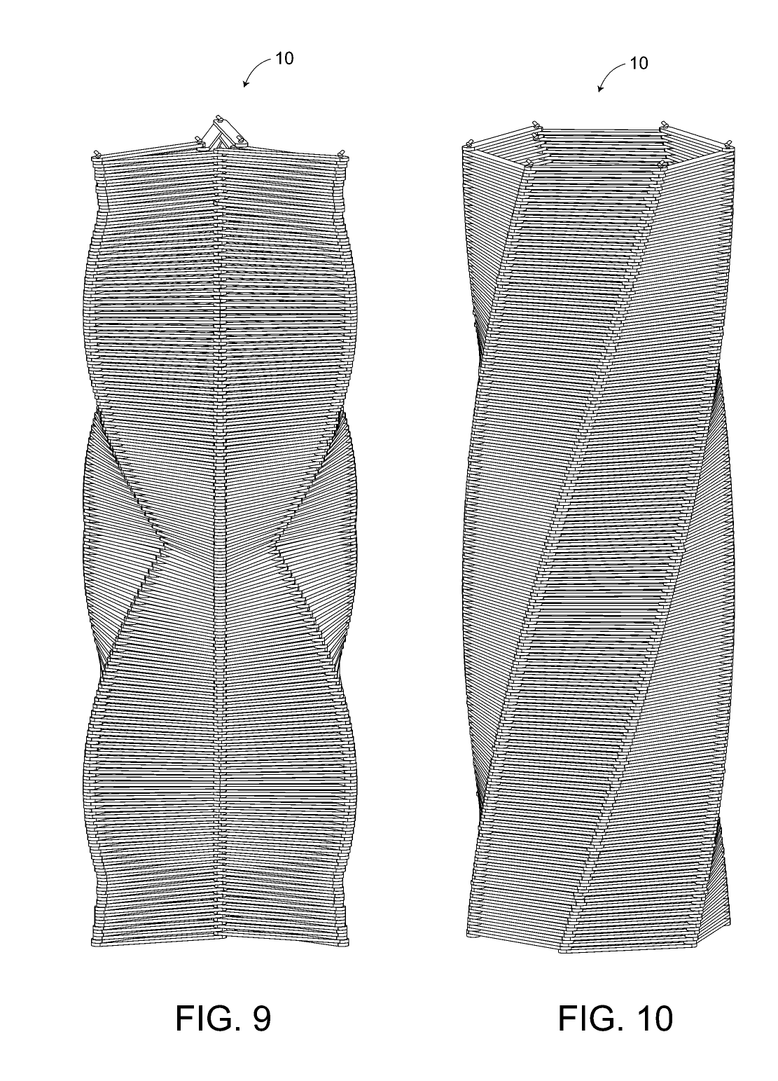

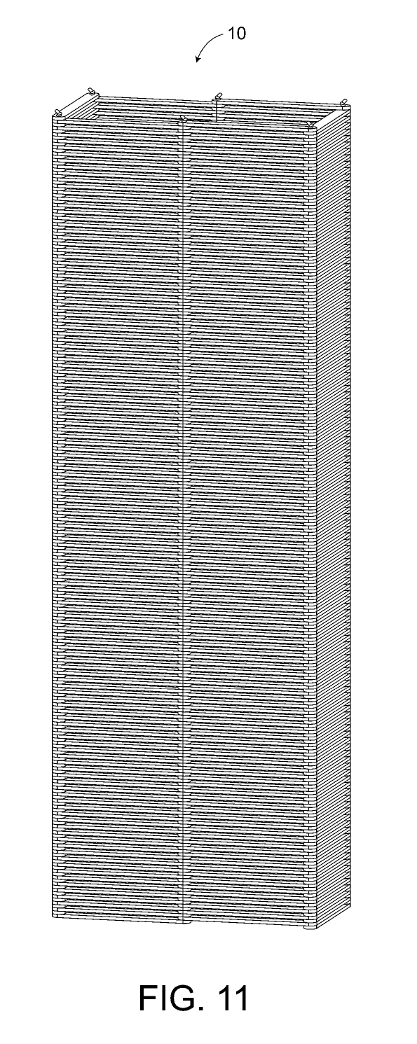

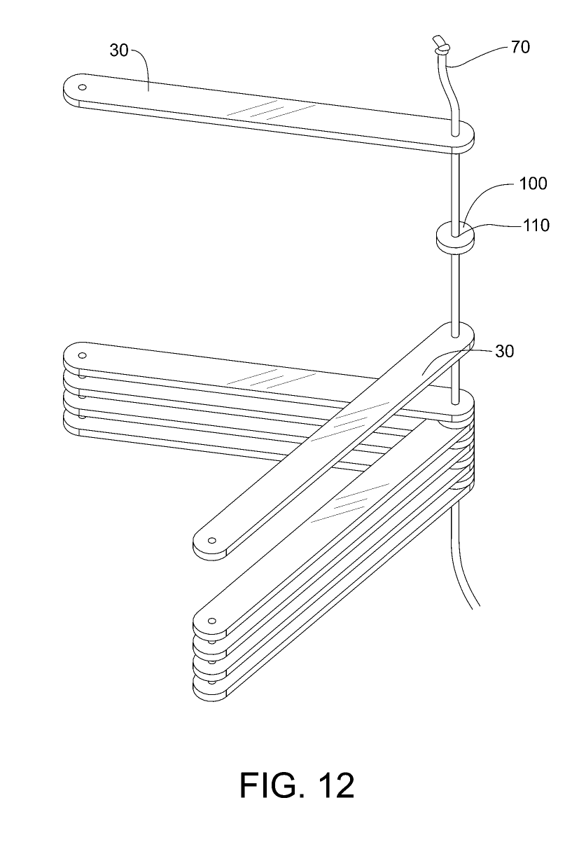

In use, the column 60 may be placed around the lamp 20 such that light is diffused by the interlaced slats 30 (FIG. 4). The slats 30 are positionable so that one geometrically shaped ring 50 may be only slightly differently shaped than its immediately adjacent rings 50, such adjacent rings 50 being somewhat constrained by the size of the aperture 35 in each slat 30 and the relative diameter and flexibility of the flexible cord 70. As such the lamp shade 10 may be adjustable, the column 60 thereof taking any number of various forms, some of which are illustrated in FIGS. 1, 2, 9, 10, and 11. The effect of adjusting the lamp shade 10 allows a variable pattern of light to escape from the sides of the lamp shade 10 and from the open top end thereof. In an alternate embodiment of the invention, illustrated in FIG. 12, the gaps formed between rings though which light may pass may be widened by further including a plurality of gauge rings 100 between adjacent slats 30. Each gauge ring 100 includes an aperture 110 therein for receiving the flexible cord 70, whereby each gauge ring 100 may be fixed between slats 30 on the flexible cord 70. The thickness of the gauge ring 100 may be modified, as well as the thickness of each slat 30, in order to achieve a suitable light diffusing effect for any given environment or application. In this manner, the lamp shade 10 is highly adjustable in both the manner in which light is diffused from the lamp shade 10, and in the ornamental appearance of the lamp shade 10.

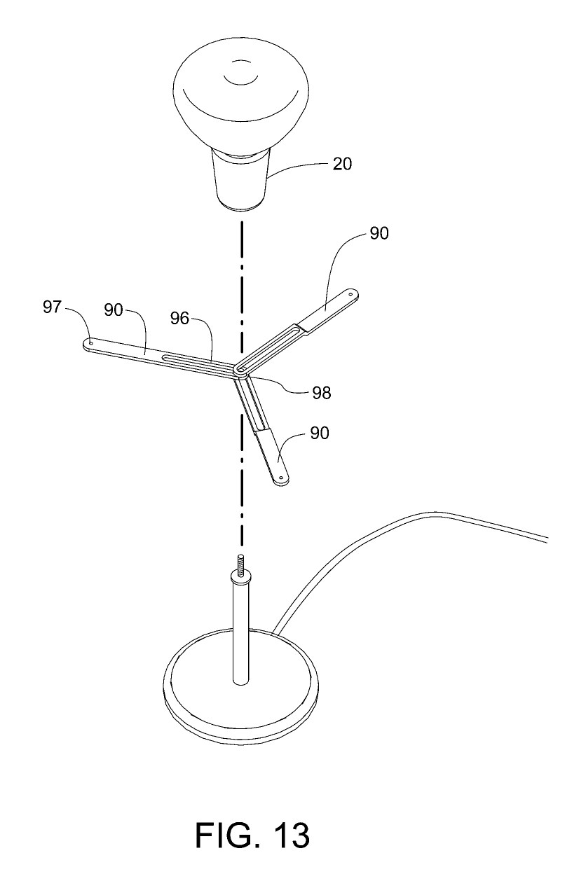

In addition to an embodiment wherein the lamp shade 10 is placed over the lamp 20, the lamp shade 10 may also be mounted directly to the lamp 20. In such an embodiment, the lamp shade 10 further includes a support bracket 90 (FIGS. 7 and 13) having at least one end 97 that includes an aperture 95 therein, and another end 98 that is slidably fixed to the lamp 20 along a slotted aperture 96 therein. The aperture 95 of the one end 97 of the bracket 90 is co-aligned with one pivot axis 40 of the column 60 and positioned between two slats 30 thereof. The flexible cord 70 traverses the aperture 95 of the bracket 90 as well as the apertures 35 of each adjacent slat 30, whereby the bracket 90 holds the column 60 in a vertically fixed position with respect to the lamp 20, while allowing adjustment of the lamp shade 10. Other mounting means may be readily fashioned to hold the lamp shade 10 to the lamp 20, as is common in the art.

While a particular form of the invention has been illustrated and described, it will be apparent that various modifications can be made without departing from the spirit and scope of the invention. For example, slats 30 of varying sizes, thicknesses, and shapes may be used. Likewise, some rings 50 may have a different number of slats 30 than their immediately adjacent rings 50. Each slat 30 is preferably made from wood, but can also be made from a wide variety of other rigid or semi-rigid materials such as plastic, metal, rock, cement, fiberglass, rubber, glass, ceramic, paper, or the like. Indeed, a variety of materials for the slats 30 may be used in the same lamp 10. Thus, a wide variety of adjustable and customizable designs may be obtained with the present invention. Accordingly, it is not intended that the invention be limited, except as by the appended claims.

What is claimed is:

1. A lamp shade for placement around a lamp, comprising:
a plurality of elongated slats, each slat comprising a top surface, a bottom surface, at least one side surface, and an aperture proximate to each of a first end and a second end thereof, each aperture traversing one slat from the top surface through the slat to the bottom surface, each first end of each slat interlaced with the second end of at least one other slat such that apertures of each slat are coaxially aligned, the coaxially aligned apertures forming a pivot axis therethrough, a plurality of such aligned slats in succession forming a geometrically shaped ring, a plurality of such rings stacked on top of each other such that each pivot axis of one ring is substantially aligned with the pivot axis of an immediately adjacent ring, the stack of rings forming a column; and
a flexible cord traversing each coaxially aligned aperture of each slat along each aligned pivot axis, each flexible cord including a stopping means at each end;
whereby the column may be placed around the lamp such that light is diffused by the interlaced slats, the slats being positionable so that one geometrically shaped ring may be only slightly differently shaped than its immediately adjacent ring.

2. The lamp shade of claim 1 wherein each geometrically shaped ring is comprised of an even number of slats, such that the lamp shade may be folded into a generally flat configuration and rolled into a rolled configuration.

3. The lamp shade of claim 1 wherein each geometrically shaped ring is comprised of an odd number of slats.

4. The lamp shade of claim 1 wherein the flexible cord is also an elastic cord.

5. The lamp shade of claim 1 wherein the stopping means of each cord is a knot in the cord, the knot being larger than each aperture of each slat.

6. The lamp shade of claim 1 wherein each geometrically shaped ring is comprised of three slats.

7. The lamp shade of claim 1 wherein each geometrically shaped ring is comprised of four slats.

8. The lamp shade of claim 1 wherein each geometrically shaped ring is comprised of five slats.

9. The lamp shade of claim 1 wherein each geometrically shaped ring is comprised of five slats.

10. The lamp shade of claim 1 wherein each geometrically shaped ring is comprised of six slats.

11. The lamp shade of claim 1 wherein each geometrically shaped ring is comprised of seven slats.

12. The lamp shade of claim 1 wherein each geometrically shaped ring is comprised of eight slats.

13. The lamp shade of claim 1 wherein each geometrically shaped ring is comprised of nine slats.

14. The lamp shade of claim 1 wherein each geometrically shaped ring is comprised of ten slats.

15. The lamp shade of claim 1 wherein each geometrically shaped ring is comprised of eleven slats.

16. The lamp shade of claim 1 wherein each geometrically shaped ring is comprised of twelve slats.

17. The lamp shade of claim 1 further including a support bracket having at least one end that includes an aperture and another end slidably fixed to the lamp with a slotted aperture, the aperture of the one end of the bracket being co-aligned with one pivot axis and positioned between two slats, the flexible cord traversing the aperture of the bracket, whereby the bracket holds the column in a vertically fixed position with regards to the lamp.

18. The lamp shade of claim 1 further including a plurality of gauge rings, each gauge ring including an aperture therein for receiving the flexible cord, whereby each gauge ring may be fixed between slats on the flexible cord.
